(19) United States
(12) Patent Application Publication
(10) Pub. No.: US 2005/0147459 A1
(43) Pub. Date: Jul. 7, 2005

(54) Product dispensing device and container equipped therewith

(76) Inventor: Jacques Gerbron, Menton (FR)

Correspondence Address: YOUNG & THOMPSON, 745 SOUTH 23RD STREET, 2ND FLOOR, ARLINGTON, VA, 22202, US

(21) Appl. No.: 10/508,036

(22) PCT Filed: Mar. 4, 2003
(86) PCT No.: PCT/FR03/00680

(30) Foreign Application Priority Data
Mar. 21, 2002 (FR) 02/03503

(51) Int. Cl. B43K 5/00

(52) U.S. Cl. 401/202

(57) ABSTRACT

A product dispensing device (1) includes an applicator mounted mobile relative to a housing (6) between a retracted closure position and an extended product dispensing position, further including elastic elements between the housing (6) and the applicator. The elastic elements include an elastically deformable and sealed hollow body preventing the passage of any product between the bottom of the housing and the base. A container equipped therewith is also disclosed.

The present invention relates to a device for application of a product as well as a receptacle provided with this device.

The invention will find application in the field of the application and dispensing of different products that can be present in liquid, slightly viscous or pulverulent form. In particular, fluids of low viscosity can be applied by the present invention.

The industrial fields in question are not limited, but could be for example, cosmetics or household products.

The invention permits, particularly when the cap is removed, an optimum passage of product (such as desired and established by the manufacturer). The applicator is preferably supplied by gravity (if desired with the help of the urging of pressure on an external wall of the receptacle when the latter is flexible) with product contained in the receptacle when the latter is positioned inverted.

The conventional applicator supports require the preliminary intervention of a user. This intervention can consist in:
a rotation of the applicator before supply and then, again, a rotation in the reverse direction to stop the supply,
a push on the applicator during distribution of the product to permit its passage between the receptacle and the applicator (often of an absorbent or traverseable type), which renders the operation difficult in certain uses such as cosmetics. In particular, it is necessary to provide a push on the applicator before obtaining sufficient product supply.

According to this prior art, the applicators have the drawback of not permitting or clearly permitting the monitoring of the passage of the product. It is thus frequent that the product gives rise to plugging of the applicator, particularly when it is held in a retracted position in case of non-use.

EP-A-1 094 011 defines the state of the art and shows only a complicated construction with a closure flap for the passage of the product. This design is of quite limited interest.

U.S. Pat. No. 4,480,940 does not permit closing the passage of the product between the reservoir and the applicator. This latter is thus always supplied, with the mentioned drawbacks.

Another problem encountered in this connection is the drying of the applicator during non-use.

To overcome these drawbacks, it has been suggested to produce a closure for the supply of a product when the applicator is in a non-use position. In this connection, FR-A-2 662 426 provides an applicator device with a closure for a receptacle in which the throat of the receptacle is provided with a closure capsule delimiting a sleeve for the guidance of a flap comprising closure means for the capsule and means for dispending fluid contained in the receptacle when the flap is raised by resilient members interposed between said capsule and said flap. In this way, any risk of plugging or inopportune passage of product toward the applicator when the latter is in a non-use condition, is precluded. The opening of the product supply takes place only when the applicator cap is removed, by means of displacement of the applicator freeing an opening for passage of the product.

Such a device however is not free from drawbacks.

In particular, the removal of the cap of the applicator must give rise automatically to the opening of the supply circuit of the product. To do this, resilient members are interposed between said capsule and said flap. These members are constituted, according to this reference, by a compression spring.

Such a spring constitutes a separate supplemental piece to be mounted in the applicator device and gives rise to increase of cost of production and assembly.

Moreover, it involves a resilient member that is cumbersome and requires, for its good operation, ensuring the sealing upstream of the spring.

As a result, the configuration of the applicator device according to FR-A-2 662 426 is complicated to ensure the housing and isolation of the spring.

The present invention permits overcoming the drawbacks of the devices known to the present and provides, to do this, an improved applicator device which has the advantage of having particular resilient means ensuring resilience and sealing. They can be integrated in the base of the applicator. In this way, the resilient means are formed of a single piece and a single material as the material of the applicator so as to reduce the cost of production and assembly.

Another advantage of the invention is that the applicator is movable between a retracted position and an extended position within a seat. This arrangement ensures optimum protection of the applicator in the retracted position and minimum size of the resulting assembly.

Moreover, movement to the retracted position is easily predetermined by abutments constituted in the form of flanges at the upper end of the seat and of the applicator.

Assembly is also facilitated because a simple snap-in of the device on the neck of a receptacle can suffice.

Other objects and advantages will become apparent in the course of the description which follows, of a preferred embodiment and of modifications of construction of the elastic means, this description not being limiting of the invention.

The present invention relates to a device for application of a product, comprising an applicator movably mounted relative to a seat, between a retracted closed position and an extended dispensing position for the product, comprising moreover resilient means between the seat and the applicator, these resilient means comprising a hollow elastically deformable and sealed body preventing any product from passing between the bottom of the seat and the base.

According to preferred modifications, this device is such that
the resilient means are integrated with the base,
the hollow body is of annular cross-section,
the applicator is movably mounted within the seat,
the seat comprises a flange adapted to be applied to the neck of the receptacle,
the applicator comprises a flange adapted to come into bearing against the flange of the seat, in the retracted position,
the resilient means are formed by a bellows applied against the bottom of the seat,
the hollow body has the shape of a portion of a sphere,
the base comprises at least one supply hole for product to the absorbent member,
the bottom of the seat comprises an inlet opening, the base comprises a closure finger configured to close the inlet opening when the hollow body is deformed.

The invention also relates to a receptacle provided with the device.

The accompanying drawings are given by way of example and are not limiting of the invention. They represent only an embodiment of the invention and will permits its easy comprehension.

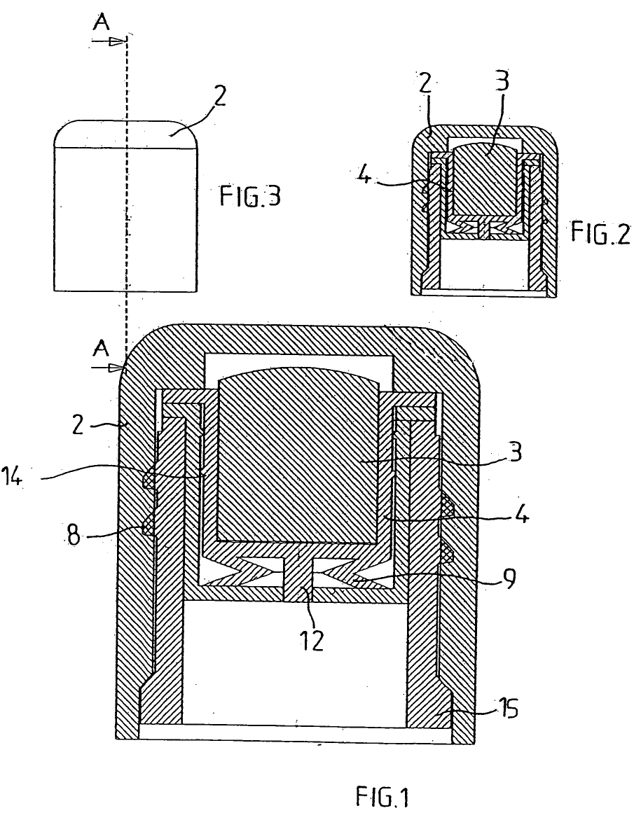

FIG. 1 is an enlarged cross-sectional view of a first embodiment of the device according to the invention, in the rest position.

FIG. 2 is a cross-sectional view on a smaller corresponding scale along the line A-A of FIG. 3, showing the exterior of the device provided with a cap.

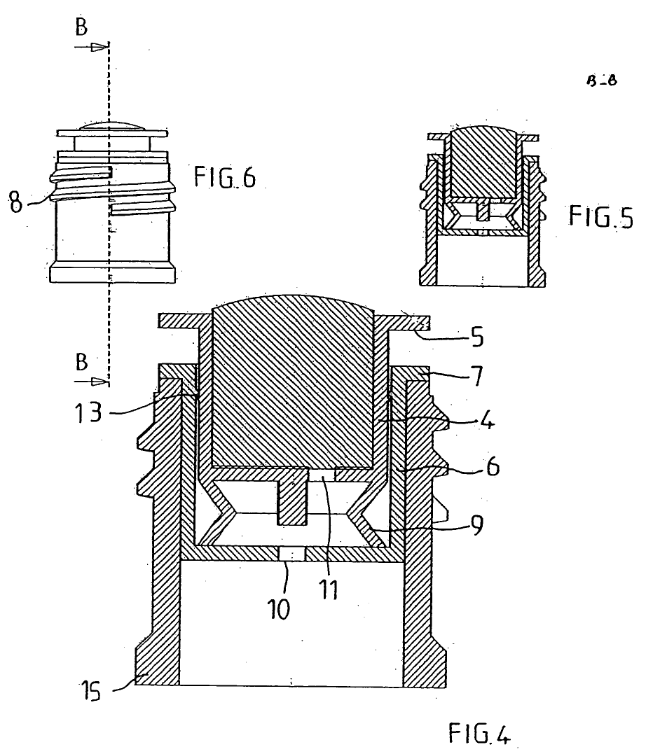

FIGS. 4 and 5 show the device of FIGS. 1, 2 and 3 in the extended position.

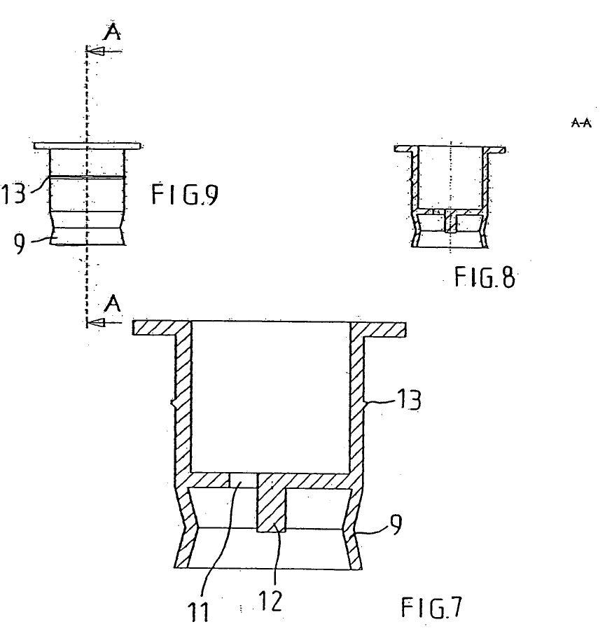

FIG. 6 is a side view.

FIGS. 7, 8 and 9 show an embodiment of the base of the applicator.

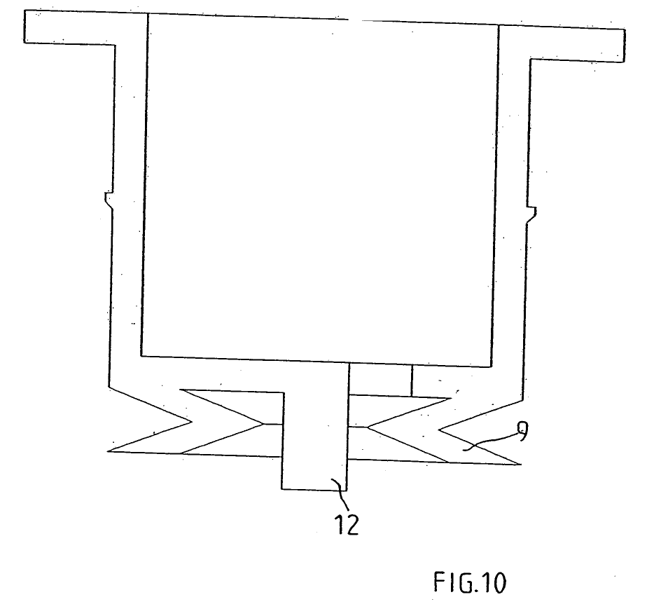

FIG. 10 is another view in the retracted position.

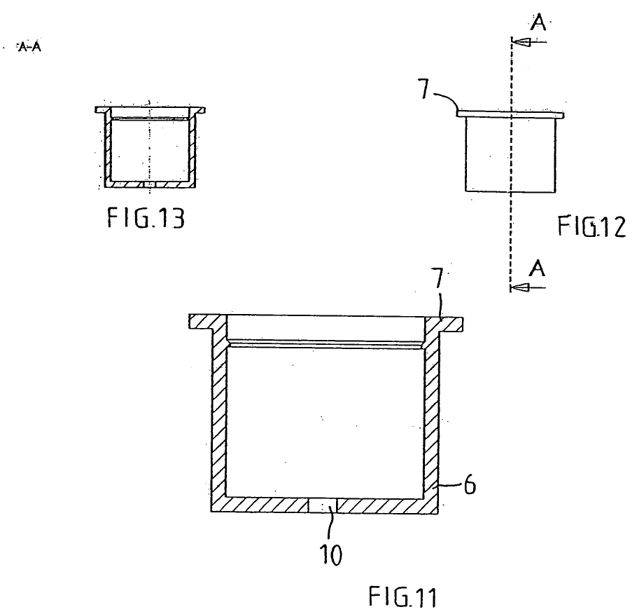

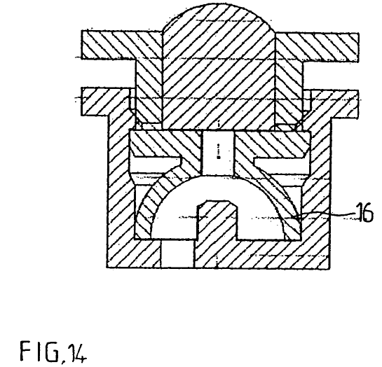

FIGS. 11, 12 and 13 show an embodiment of the seat usable in the device.

FIG. 14 shows two other embodiments of resilient means.

Referring to FIG. 1, the device according to the invention comprises an applicator preferably constituted in two parts: an absorbent member 3 disposed in a base 4. The base 4 can surround the member 3 or at least serve as a support for its lower surface.

The applicator thus constituted is movably mounted within a seat 6. The seat 6 itself can be mounted in a cylindrical member, for example constituted by the neck 15 of a receptacle.

The holding in retracted position is preferably effected by force exerted by a cap 2 covering the applicator device. The cap 2 can be secured by a screw thread 8 on the neck 15. Other securement means however are not excluded.

To produce the extension of the applicator upon removal of the cap 2, resilient means are present in the base 4 of the applicator.

According to the invention, they permit forming a sealed chamber between the base 4 and the bottom of the seat 6. They thus have a double function. The chamber serves as an intermediate zone between the product reservoir and the applicator.

In the case of FIG. 1, these resilient means are constituted by a bellows 9 having one or several bend zones according to the desired resilient properties and the height to be given to the resilient means.

In the case of FIG. 1, and referring also to FIG. 4, the bellows 9 constitutes both a resilient member for extension of the applicator and a sealing member avoiding any passage of the product to be applied toward the sidewalls of the seat 6.

More generally, the resilient means could be formed by a hollow body of annular section. The bellows 9 is one example, as is also the dome 16 of FIG. 14.

The opening or closing of the device takes place in the following manner.

In the extended position, an inlet opening 10 formed in the bottom of the seat 6 ensures the passage of the product from the internal volume of the receptacle toward the applicator.

The absorbent member 3 of the applicator is supplied with product by means of a supply hole 14.

Of course, the number and shape of the openings 10 and the holes 11 are not limited and will be suitable to the nature of the product to be transmitted as well as to the regulation of the desired flow rate.

In the course of the formation of a bellows 9 or a dome 16, an intermediate chamber is created by the bottom of the seat 6, the internal walls of the bellows 9 and the external surface of the base 4 of the applicator. Additional sealing means are not required but can be added for example in the form of a sealing ring.

When the applicator is in retracted position, the closing of the inlet for the product takes place by means of closing fingers 12 of a shape and number corresponding to those of the inlet openings 10.

Each closure finger 12 is adapted to close an inlet opening 10 when it is in the retracted position.

In the retracted position, an abutment of the applicator is formed on the seat 6 by means of flanges 5, 7 formed respectively on the base 4 of the applicator and on the end of the seat 6.

In the extended position, there is preferably provided a path limiter 13 in the form of two corresponding surfaces formed, on the one hand, on the internal wall of the seat 6 and, on the other hand, on the external wall of the base 4 of the applicator at a predetermined position to limit the path of translation of the applicator.

There will preferably be used polymeric or liquid silicone materials to constitute the members of the device according to the invention. The seat 6 can thus be constituted of medium density polyethylene and the base 4 of the applicator be formed of polyoxymethacrylate or of polypropylene or else liquid silicone.

### References

2. cap
3. absorbent member
4. base
5. flange
6. seat
7. flange
8. screw thread
9. bellows
10. inlet opening
11. supply hole
12. closure finger
13. path limited
14. joint
15. neck
16. dome

1. Device for applying a product, comprising an applicator having an absorbent member (3) disposed in a base (4), said applicator being movably mounted relative to a seat (6) between a retracted closed position and an extended position for distribution of product, comprising moreover resilient means between the seat (6) and the applicator, wherein the resilient means comprise a hollow resiliently deformable and sealed body preventing any product from passing between the bottom of the seat (6) and the base (4).

2. Device according to claim 1, wherein the resilient means are integrated into the base (4).

3. Device according to claim 1, wherein the hollow body is of annular cross-section.

4. Device according to claim 1, wherein the applicator is movably mounted within the seat (6).

5. Device according to claim 4, wherein the seat (6) comprises a flange (7) adapted to be applied against the neck (15) of the receptacle.

6. Device according to claim 5, wherein the applicator comprises a flange (5) adapted to come to bear against the flange (7) of the seat (6) in the retracted position.

7. Device according to claim 1, wherein the resilient means are formed by a bellows (9) that is applied against the bottom of the seat (6).

8. Device according to claim 1, wherein the hollow body has the shape of a portion of a sphere.

9. Device according to claim 1, wherein
the base (4) comprises at least one supply hole (11) for product to the absorbent member (3),
the bottom of the seat (6) comprises an inlet opening (10),
the base (4) comprises a closure finger (12) shaped to close the inlet opening (10) when the hollow body is deformed.

10. Receptacle provided with a device according to claim 1.
